(19) United States
(12) Patent Application Publication
(10) Pub. No.: US 2026/0343680 A1
(43) Pub. Date: Oct. 29, 2026

(54) ELECTRIC HEATING STRUCTURE WITH OVERHEATING PROTECTION LAYER, AND CONTROL SYSTEM AND METHOD THEREFOR

(71) Applicant: FOSHAN SHUNDE CARBON UNIVERSE INTELLIGENT TECHNOLOGY CO., LTD, Foshan (CN)

(72) Inventor: Jinghui ZHOU, Foshan (CN)

(73) Assignee: FOSHAN SHUNDE CARBON UNIVERSE INTELLIGENT TECHNOLOGY CO., LTD, Foshan (CN)

(21) Appl. No.: 19/695,050

(22) Filed: Jun. 2, 2026

Related U.S. Application Data
(63) Continuation of application No. PCT/CN2026/093556, filed on Apr. 28, 2026.

(30) Foreign Application Priority Data
Apr. 29, 2025 (CN) 2025105572575
May 12, 2025 (CN) 2025106017837
May 12, 2025 (CN) 2025106017841
May 21, 2025 (CN) 2025106596488

(51) Int. Cl. H05B 3/00; H05B 1/02

(52) U.S. Cl. CPC H05B 3/0019; H05B 1/02

(57) ABSTRACT

An electric heating structure with an overheating protection layer, and a control system and method therefor are provided, and the electric heating structure includes a base layer, where an electrothermal conductive structure is disposed in the base layer; the electrothermal conductive structure includes heating wires uniformly distributed in the base layer, and a wave-shaped conductive structure is electrically connected between both ends of each of the heating wires; detection layers are respectively disposed on both sides of the base layer, and wave-shaped detection conductive wires are uniformly distributed on the detection layers; a main current detection circuit is disposed between a plurality of the wave-shaped detection conductive wires; junctions between the heating wires, the wave-shaped conductive structures, and the base layer are fixed with high-temperature-resistant wires; and the present disclosure is characterized by a reasonable structure, accurate detection, fast response, and long service life.

### TECHNICAL FIELD

The present disclosure relates to the technical field of electric heating equipment, and in particular to an electric heating structure with an overheating protection layer, and a control system and method therefor.

### BACKGROUND

Electric heating structures are widely applied in household appliances, industrial heating equipment, thermal insulation equipment, and other scenarios, and are mainly used to achieve heating or thermal insulation effects by converting electric energy into heat energy through heating elements. During long-term use, electric heating structures in the prior art are prone to local overheating, and poor local contact of heating wires, uneven heat dissipation, or circuit abnormality leads to excessive local overheating, equipment damage, short circuit, even fire and other potential safety hazards, thereby severely affecting the use safety and service life.

Currently, single temperature sensor detection or fuse protection is typically employed for overheating protection of electric heating structures in the prior art, and there exist defects such as low detection sensitivity, slow response, and limitations in protection range. A temperature sensor only detects a temperature of an overall area, and cannot accurately capture local overheating of a single heating wire; and a fuse wire is a one-time protective component and needs to be replaced after fusing, thereby resulting in use inconvenience and high maintenance cost. Additionally, conductive connection stability of an electric heating structure in the prior art is insufficient, and a junction between a heating wire and a conductive structure is prone to loosening or detachment, thereby shortening the service life; and unreasonable design of heat dissipation structure, and uneven heat distribution, further exacerbate the risk of local overheating.

Moreover, a detection structure of an electric heating structure in the prior art is imperfect with limited detection coverage, and blind spots of detection that easily occur result in failure to find local overheating in a timely manner; and poor synergy between heat dissipation and conductive detection leads to difficulty to balance heat dissipation effect and detection sensitivity. Therefore, in view of the above technical defects of the electric heating structures in the prior art, there is an urgent need for an electric heating structure with an overheating protection layer and a control system therefor that are characterized by a reasonable structure, accurate detection, fast response, and long service life.

Therefore, further improvement is required in the technical field of electric heating equipment in the prior art.

### SUMMARY

An object of the present disclosure to provide an electric heating structure with an overheating protection layer, and a control system and method therefor, achieve accurate detection and rapid response to local overheating of the electric heating structure, enhance conductive stability and heat dissipation uniformity, prolong the service life of equipment, and enhance use safety.

To achieve the above object, the present disclosure adopts the following technical solution: an electric heating structure with an overheating protection layer, including a base layer, where an electrothermal conductive structure is disposed in the base layer; the electrothermal conductive structure includes a plurality of heating wires uniformly distributed in the base layer, and a wave-shaped conductive structure is electrically connected between both ends of each of the heating wires; detection layers are respectively disposed on both sides of the base layer, and wave-shaped detection conductive wires equal in number to the heating wires are uniformly distributed on outer surfaces of the detection layers; a main current detection circuit is disposed between a plurality of the wave-shaped detection conductive wires; junctions between the heating wires, the wave-shaped conductive structures, and the base layer are fixed with high-temperature-resistant wires;
junctions between the wave-shaped detection conductive wires, the main current detection circuit, and the detection layers are also fixed by the high-temperature-resistant wires;
a controller is further included, and the controller is electrically connected to the main current detection circuit and the wave-shaped conductive structure respectively;
the electrothermal conductive structure further includes a positive-electrode conductive structure and a negative-electrode conductive structure respectively connected to both ends of the plurality of heating wires;
outer sides of the plurality of heating wires are covered with a meltable layer, and an outer side of the meltable layer is covered with a conductive detection layer;
the conductive detection layer is electrically connected to the controller, the controller is electrically connected to a control switch, the control switch is electrically connected to the positive-electrode conductive structure and the negative-electrode conductive structure, and the positive-electrode conductive structure and the negative-electrode conductive structure are electrically connected to the wave-shaped conductive structure respectively;
a carbon nanotube conductive coating is disposed on a surface of the conductive detection layer, and graphene heat dissipation sheets are embedded in the carbon nanotube conductive coating; and
a uniform heat dissipation layer is further disposed between the base layer and the plurality of heating wires.

Further, the base layer and the detection layers are made of a material such as non-woven fabric or a PVC film;
the heating wires are made of a material such as carbon fiber, nickel-chromium alloy, chromium-aluminum alloy, tungsten wire, or molybdenum wire;
the wave-shaped conductive structure includes a plurality of wave-shaped conductive wire sets vertically arranged;
each of the wave-shaped conductive wire sets includes two parallel wave-shaped conductive wire sets bilaterally arranged in a symmetrical manner;
the plurality of wave-shaped conductive wire sets and the plurality of heating wires are arranged in a staggered manner;
the two parallel wave-shaped conductive wire sets are arranged in a staggered manner, and the heating wire is disposed between the two parallel wave-shaped conductive wire sets;
each of the parallel wave-shaped conductive wire sets includes two wave-shaped conductive wires extending in parallel along an S-shaped path;
each of the wave-shaped detection conductive wires is S-shaped and wave-shaped, and correspondingly overlapped on an outer side of one of the heating wires, and electrical signal isolation is achieved via the detection layer;
the wave-shaped arrangement of the wave-shaped detection conductive wires increases a detection coverage range for local overheating of the heating wires;
the main current detection circuit includes a plurality of vertical detection metal wires vertically arranged; and
each of the vertical detection metal wires includes an upper detection conductive metal piece and a lower detection conductive metal piece respectively disposed on an upper surface and a lower surface of the wave-shaped detection conductive wire.

Further, the vertical detection metal wires are made of one of copper, aluminum alloy, or stainless steel;
the wave-shaped detection conductive wires are made of Wood's metal;
each of the wave-shaped detection conductive wires is externally wrapped with an outer soft frame, a plurality of circular frames are uniformly arranged transversely on an inner side of the outer soft frame, and the wave-shaped detection conductive wire penetrates through the plurality of circular frames along a wave-shaped path; and
an outer layer is disposed on an outer side of the plurality of outer soft frames, and the outer layer is configured to enclose the plurality of circular frames.

Further, the plurality of heating wires are arranged parallel to each other and spaced apart from each other in a vertical direction of the base layer.

Further, a wave-shaped conductive line structure includes two wave-shaped conductive lines that are bilaterally arranged in a symmetrical and staggered manner, and the wave-shaped conductive lines are electrically connected to corresponding ends of the heating wires.

Further, junctions between the wave-shaped conductive lines and the heating wires are fixed with high-temperature-resistant wires;
the meltable layer is made of a low-melting-point hot-melt material; and
the uniform heat dissipation layer includes a high thermal conductivity layer, a medium thermal conductivity layer, and a low thermal conductivity layer, the high thermal conductivity layer is arranged in contact with the plurality of heating wires, and the low thermal conductivity layer is arranged in contact with the base layer.

Further, the high thermal conductivity layer, the medium thermal conductivity layer, and the low thermal conductivity layer are each filled with thermally conductive particles of different particle sizes;
the high thermal conductivity layer is made of a graphene composite material or a boron nitride composite material; and
the medium thermal conductivity layer is made of a carbon nanotube composite material or an epoxy resin composite material.

Further, an aerogel thermal insulation buffer layer is disposed between the base layer and the meltable layer, and the aerogel thermal insulation buffer layer has a honeycomb structure;
a plurality of micro temperature sensors are uniformly distributed in the aerogel thermal insulation buffer layer, and the micro temperature sensors are electrically connected to the controller; and
the graphene heat dissipation sheets and the conductive detection layer collectively form a composite conductive heat dissipation structure.

The control method for an overheating protection layer includes the following control steps:
S1, the controller employs a relay or electronic switch circuit structure, and a detection terminal of the controller is electrically connected to the main current detection circuit;
S2, when a local temperature of the electric heating structure is excessively high such that temperature anomaly occurs at a certain position of one of the heating wires, the detection layer at a corresponding position melts;
S3, after the detection layer melts, the heating wire at a corresponding position comes into contact with the wave-shaped detection conductive wire to generate an electric current, and the electric current is transmitted to the wave-shaped detection conductive wire;
S4, the wave-shaped detection conductive wire transmits a current signal to the controller through the main current detection circuit; and
S5, the controller cuts off a main power supply circuit of the positive-electrode conductive structure and the negative-electrode conductive structure according to the received current signal.

Further, the following steps are further included:
S6, the wave-shaped detection conductive wire made of Wood's metal has a melting point ranging from 70 °C to 90 °C; when the local temperature of the electric heating structure is excessively high, the heating wire melts the wave-shaped detection conductive wire at a corresponding position;
S7, after the wave-shaped detection conductive wire at the corresponding position melts, a resulting molten solution covers an interior of the corresponding circular frame; and
S8, a coverage area of the wave-shaped detection conductive wire is increased to stably receive a current signal from the heating wire at the corresponding position, thereby preventing failure of electric signal transmission caused by a hollow gap between the wave-shaped detection conductive wires wavily arranged and the heating wires linearly arranged.

In summary, compared with the prior art, the present disclosure has the following beneficial effects:

The present disclosure overcomes the deficiencies in the technical field of electric heating equipment in the prior art, and has the following advantages through structural arrangement, such as accurate overheating detection and rapid response: By arranging the detection layers on both sides of the base layer and the wave-shaped detection conductive wires corresponding to the heating wires, the present disclosure increases the detection coverage range through the wave-shaped design, accurately captures local overheating of a single heating wire through the main current detection circuit and the controller, achieves quick triggering of a current signal after melting of the detection layer, and eliminates potential safety hazards since the controller cuts off the power supply circuit in a timely manner. Junctions between the heating wires and the wave-shaped conductive structure, and junctions between the wave-shaped detection conductive wires and the main current detection circuits are fixed by the high-temperature-resistant wires, and the wave-shaped conductive structure includes a plurality of wave-shaped conductive wire sets arranged in a staggered manner, which enhances the stability of conductive connection, prevents loosening and detachment, and prolongs the service life of equipment. Arrangement of the uniform heat dissipation layer divided into the high thermal conductivity layer, the medium thermal conductivity layer, and the low thermal conductivity layer and filled with thermally conductive particles of different particle sizes, in combination with the composite conductive heat dissipation structure formed by the carbon nanotube conductive coating on the surface of the conductive detection layer and the graphene heat dissipation sheets, enables uniform heat conduction and rapid heat dissipation, and reduces the risk of local overheating. The aerogel thermal insulation buffer layer plays the roles of thermal insulation and buffering, the micro temperature sensors therein assist temperature detection, and a dual overheating protection mechanism is formed together with the melting trigger protection of the wave-shaped detection conductive wires, thereby further enhancing use safety; and through the design of the meltable layer and the wave-shaped detection conductive wires, the present disclosure achieves accurate triggering after overheating, and the structure can be reused by only replacing the wave-shaped detection conductive wire, thereby reducing maintenance cost. The base layer, the detection layers, the heating wires, and other components are made of common and easily available materials, and the structure is compact and can be widely applied to various electric heating equipment, meeting use requirements for different scenarios.

### BRIEF DESCRIPTION OF DRAWINGS

FIG. 1 is a first schematic diagram of an internal structure of the present disclosure.

FIG. 2 is a second schematic diagram of an internal structure of the present disclosure.

FIG. 3 is a third schematic diagram of an internal structure of the present disclosure.

FIG. 4 is a first perspective view of the present disclosure.

FIG. 5 is a partial enlarged view of a portion A in FIG. 4.

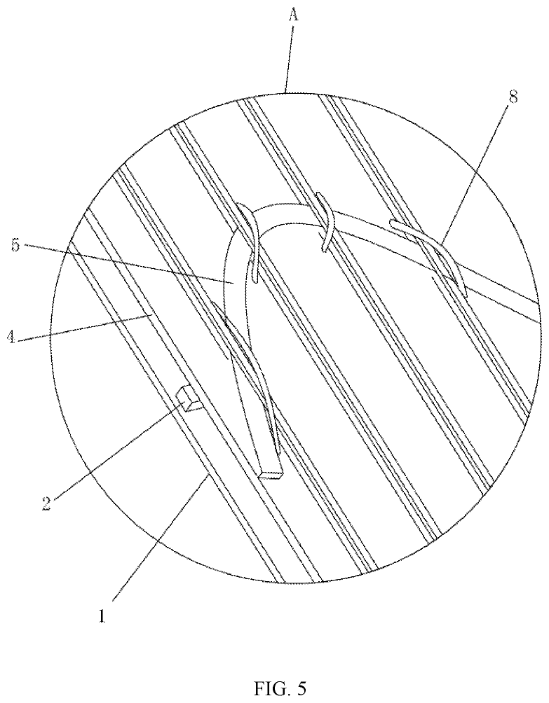

FIG. 6 is a second perspective view of the present disclosure.

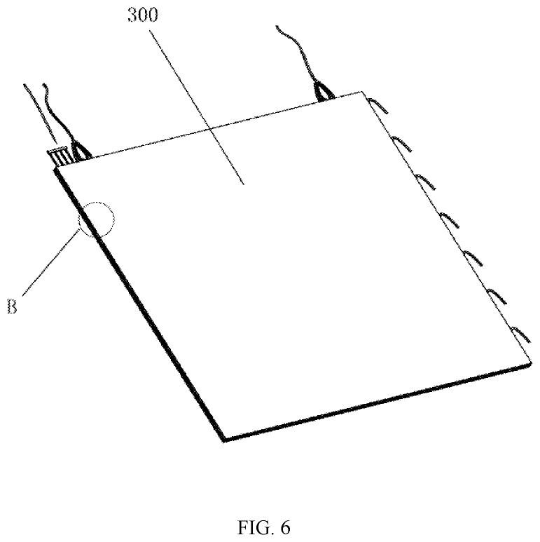

FIG. 7 is a partial enlarged view of a portion B in FIG. 6.

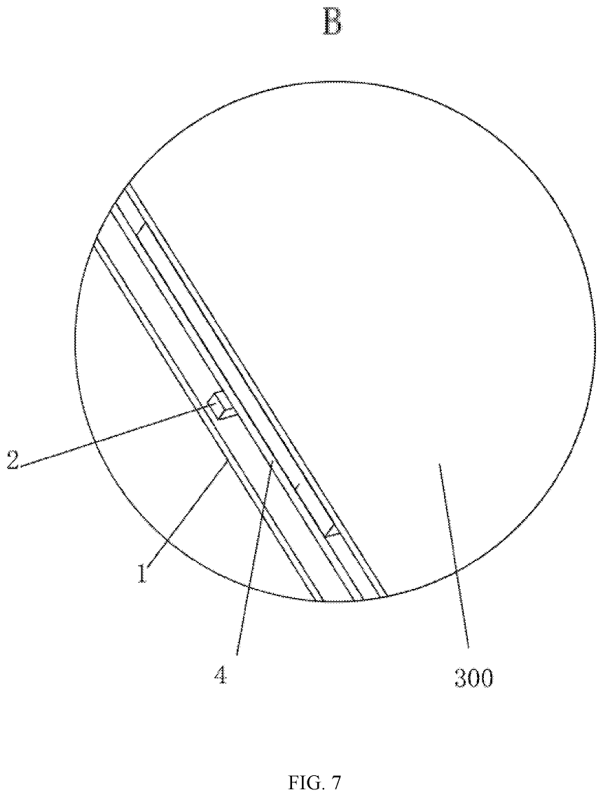

FIG. 8 is a third schematic diagram of an internal structure of the present disclosure.

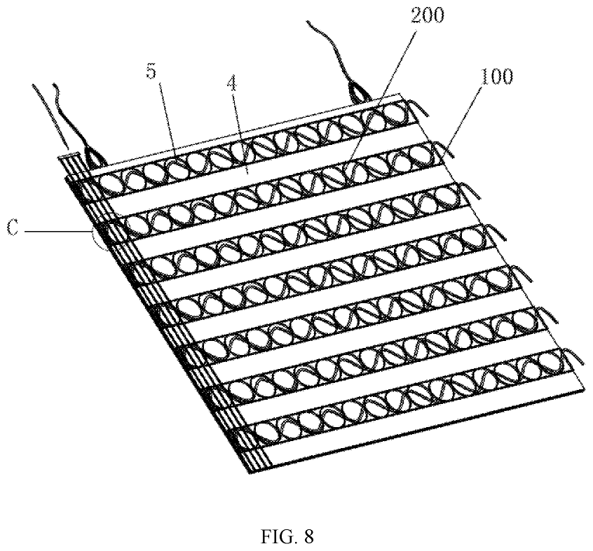

FIG. 9 is a partial enlarged view of a portion C in FIG. 8.

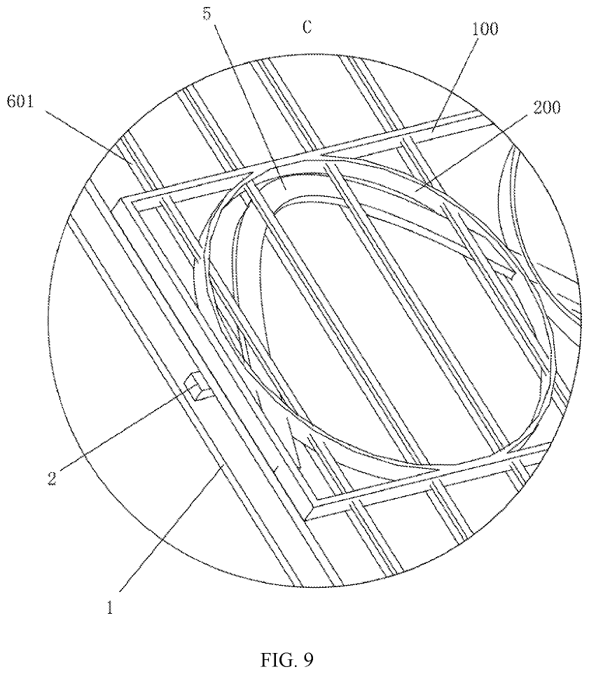

FIG. 10 is a fourth schematic diagram of an internal structure of the present disclosure.

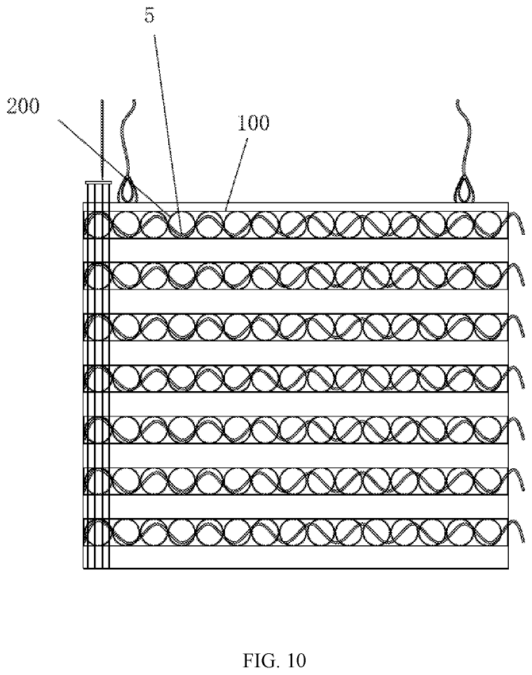

FIG. 11 is a first exploded view of Embodiment 2 of the present disclosure.

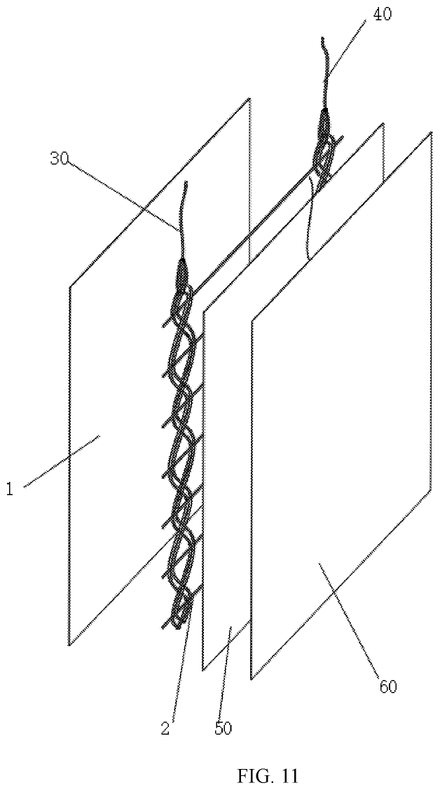

FIG. 12 is a schematic structural diagram of Embodiment 2 of the present disclosure.

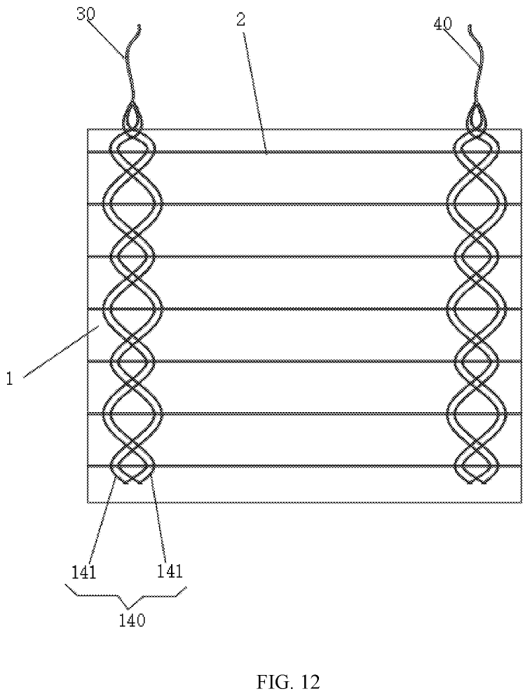

FIG. 13 is a second exploded view of Embodiment 2 of the present disclosure.

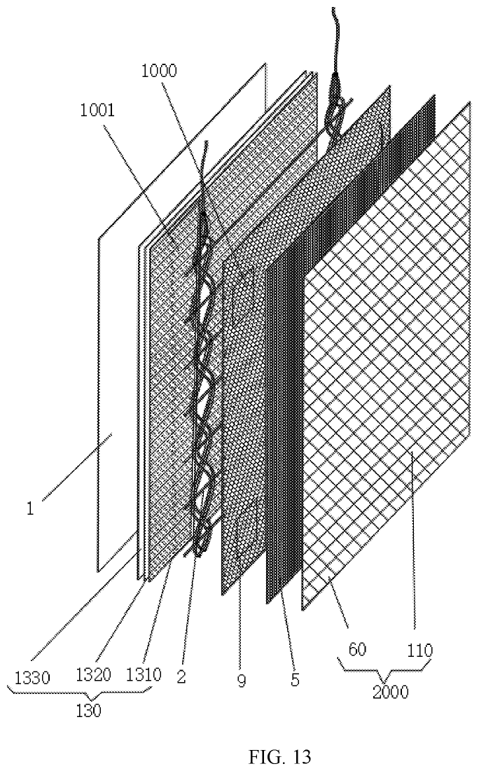

### DETAILED DESCRIPTION OF THE EMBODIMENTS

The technical solutions in the embodiments of the present disclosure will be clearly and completely described below in combination with the accompanying drawings in the embodiments of the present disclosure. Apparently, the embodiments described are merely some rather than all of the embodiments of the present disclosure. Based on the embodiments of the present disclosure, all other embodiments obtained by those of ordinary skill in the art without making creative efforts shall fall within the protection scope of the present disclosure.

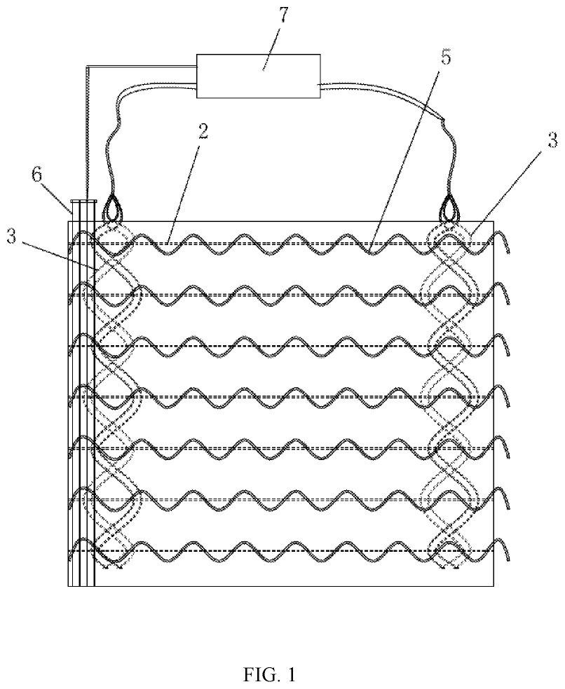

With reference to FIGS. 1 to 3, the present disclosure provides an electric heating structure with an overheating protection layer, including a base layer 1, where an electrothermal conductive structure is disposed in the base layer 1; the electrothermal conductive structure includes a plurality of heating wires 2 uniformly distributed in the base layer 1, and a wave-shaped conductive structure 3 is electrically connected between both ends of each of the heating wires 2; detection layers 4 are respectively disposed on both sides of the base layer 1, and wave-shaped detection conductive wires 5 equal in number to the heating wires 2 are uniformly distributed on outer surfaces of the detection layers 4; a main current detection circuit 6 is disposed between a plurality of the wave-shaped detection conductive wires 5; junctions between the heating wires 2, the wave-shaped conductive structures 3, and the base layer 1 are fixed with high-temperature-resistant wires 8;
junctions between the wave-shaped detection conductive wires 5, the main current detection circuit 6, and the detection layers 4 are also fixed by the high-temperature-resistant wires 8;
a controller 7 is further included, and the controller 7 is electrically connected to the main current detection circuit 6 and the wave-shaped conductive structure 3 respectively;
the electrothermal conductive structure further includes a positive-electrode conductive structure 30 and a negative-electrode conductive structure 40 respectively connected to both ends of the plurality of heating wires 2;
outer sides of the plurality of heating wires 2 are covered with a meltable layer 50, and an outer side of the meltable layer 50 is covered with a conductive detection layer 60;
the conductive detection layer 60 is electrically connected to the controller 7, the controller 7 is electrically connected to a control switch, the control switch is electrically connected to the positive-electrode conductive structure 30 and the negative-electrode conductive structure 40, and the positive-electrode conductive structure 30 and the negative-electrode conductive structure 40 are electrically connected to the wave-shaped conductive structure 3 respectively;
a carbon nanotube conductive coating 110 is disposed on a surface of the conductive detection layer 60, and graphene heat dissipation sheets are embedded in the carbon nanotube conductive coating 110; and
a uniform heat dissipation layer 130 is further disposed between the base layer 1 and the plurality of heating wires 2.

The base layer 1 and the detection layers 4 are made of a material such as non-woven fabric or a PVC film;
the heating wires 2 are made of a material such as carbon fiber, nickel-chromium alloy, chromium-aluminum alloy, tungsten wire, or molybdenum wire;

The wave-shaped conductive structure 3 includes a plurality of wave-shaped conductive wire sets 301 vertically arranged;
each of the wave-shaped conductive wire sets 301 includes two parallel wave-shaped conductive wire sets 302 bilaterally arranged in a symmetrical manner;
the plurality of wave-shaped conductive wire sets 301 and the plurality of heating wires 2 are arranged in a staggered manner;
the two parallel wave-shaped conductive wire sets 302 are arranged in a staggered manner, and the heating wire 2 is disposed between the two parallel wave-shaped conductive wire sets 302;
each of the parallel wave-shaped conductive wire sets 302 includes two wave-shaped conductive wires 303 extending in parallel along an S-shaped path;
each of the wave-shaped detection conductive wires 5 is S-shaped and wave-shaped, and correspondingly overlapped on an outer side of one of the heating wires 2, and electrical signal isolation is achieved via the detection layer 4;
the wave-shaped arrangement of the wave-shaped detection conductive wires 5 increases a detection coverage range for local overheating of the heating wires 2;
the main current detection circuit 6 includes a plurality of vertical detection metal wires 601 vertically arranged; and
each of the vertical detection metal wires 601 includes an upper detection conductive metal piece and a lower detection conductive metal piece respectively disposed on an upper surface and a lower surface of the wave-shaped detection conductive wire 5.

The vertical detection metal wires 601 of the present disclosure are made of one of copper, aluminum alloy, or stainless steel;
the wave-shaped detection conductive wires 5 are made of Wood's metal;
each of the wave-shaped detection conductive wires 5 is externally wrapped with an outer soft frame 100, a plurality of circular frames 200 are uniformly arranged transversely on an inner side of the outer soft frame 100, and the wave-shaped detection conductive wire 5 penetrates through the plurality of circular frames 200 along a wave-shaped path; and
an outer layer 300 is disposed on an outer side of the plurality of outer soft frames 100, and the outer layer 300 is configured to enclose the plurality of circular frames 200.

In the present disclosure, the plurality of heating wires 2 are arranged parallel to each other and spaced apart from each other in a vertical direction of the base layer 1.

In the present disclosure, a wave-shaped conductive line structure 140 includes two wave-shaped conductive lines 141 that are bilaterally arranged in a symmetrical and staggered manner, and the wave-shaped conductive lines 141 are electrically connected to corresponding ends of the heating wires 2.

In the present disclosure, junctions between the wave-shaped conductive lines 141 and the heating wires 2 are fixed with high-temperature-resistant wires;
the meltable layer 50 is made of a low-melting-point hot-melt material; and
the uniform heat dissipation layer 130 includes a high thermal conductivity layer 1310, a medium thermal conductivity layer 1320, and a low thermal conductivity layer 1330, the high thermal conductivity layer 1310 is arranged in contact with the plurality of heating wires 2, and the low thermal conductivity layer 1330 is arranged in contact with the base layer 1.

In the present disclosure, the high thermal conductivity layer 1310, the medium thermal conductivity layer 1320, and the low thermal conductivity layer 1330 are each filled with thermally conductive particles 1001 of different particle sizes;
the high thermal conductivity layer 1310 is made of a graphene composite material or a boron nitride composite material; and
the medium thermal conductivity layer 1320 is made of a carbon nanotube composite material or an epoxy resin composite material.

In the present disclosure, an aerogel thermal insulation buffer layer 90 is disposed between the base layer 1 and the meltable layer 50, and the aerogel thermal insulation buffer layer 90 has a honeycomb structure;
a plurality of micro temperature sensors 1000 are uniformly distributed in the aerogel thermal insulation buffer layer 90, and the micro temperature sensors 1000 are electrically connected to the controller 7; and
the graphene heat dissipation sheets and the conductive detection layer 60 collectively form a composite conductive heat dissipation structure 2000.

A control method for an overheating protection layer, includes the following control steps:
S1, the controller 7 employs a relay or electronic switch circuit structure, and a detection terminal of the controller 7 is electrically connected to the main current detection circuit 6;
S2. when a local temperature of the electric heating structure is excessively high such that temperature anomaly occurs at a certain position of one of the heating wires 2, the detection layer 4 at a corresponding position melts;
S3, after the detection layer 4 melts, the heating wire 2 at a corresponding position comes into contact with the wave-shaped detection conductive wire 5 to generate an electric current, and the electric current is transmitted to the wave-shaped detection conductive wire 5;
S4, the wave-shaped detection conductive wire 5 transmits a current signal to the controller 7 through the main current detection circuit 6; and
S5, the controller 7 cuts off a main power supply circuit of the positive-electrode conductive structure 30 and the negative-electrode conductive structure 40 according to the received current signal.

The control method for an overheating protection layer, further includes the following steps:
S6, the wave-shaped detection conductive wire 5 made of Wood's metal has a melting point ranging from 70 °C to 90 °C; when the local temperature of the electric heating structure is excessively high, the heating wire 2 melts the wave-shaped detection conductive wire 5 at a corresponding position;
S7, after the wave-shaped detection conductive wire 5 at the corresponding position melts, a resulting molten solution covers an interior of the corresponding circular frame 200; and
S8, a coverage area of the wave-shaped detection conductive wire 5 is increased to stably receive a current signal from the heating wire 2 at the corresponding position, thereby preventing failure of electric signal transmission caused by a hollow gap between the wave-shaped detection conductive wires 5 wavily arranged and the heating wires 2 linearly arranged.

The base layer 1 is made of a non-woven fabric material, and the electrothermal conductive structure is uniformly arranged in the base layer 1; and the electrothermal conductive structure includes 10 heating wires 2 arranged in parallel and spaced apart from each other in a vertical direction of the base layer 1, the heating wires 2 are made of a carbon fiber material, and a wave-shaped conductive structure 3 is electrically connected between both ends of each of the heating wires 2.

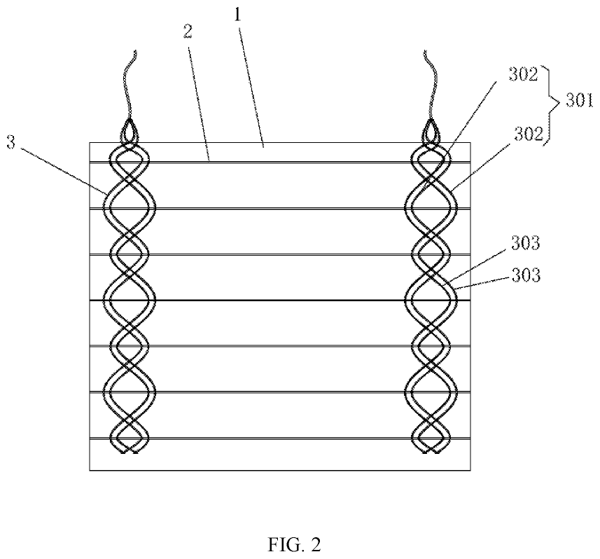

As shown in FIG. 2, the wave-shaped conductive structure 3 includes five wave-shaped conductive wire sets 301 vertically arranged, each of the wave-shaped conductive wire sets 301 includes two parallel wave-shaped conductive wire sets 302 bilaterally arranged in a symmetrical manner, and the five wave-shaped conductive wire sets 301 and the 10 heating wires 2 are arranged in a staggered manner; and the two parallel wave-shaped conductive wire sets 302 are arranged in a staggered manner, the heating wires 2 are disposed between the two parallel wave-shaped conductive wire sets 302, each of the parallel wave-shaped conductive wire sets 302 includes two wave-shaped conductive wires 303 extending in parallel along an S-shaped path, and the wave-shaped conductive wires 303 are made of a copper material.

Detection layers 4 are respectively disposed on both sides of the base layer 1, the detection layers 4 are made of a PVC film, and the ten wave-shaped detection conductive wires 5 are uniformly distributed on outer surfaces of the detection layers 4 and correspond to the heating wires 2 one by one; and each of the wave-shaped detection conductive wires 5 is S-shaped and wave-shaped and correspondingly overlapped on an outer side of one of the heating wires 2, electrical signal isolation is achieved via the detection layers 4, and the wave-shaped arrangement increases a detection coverage range for local overheating of the heating wires 2.

A main current detection circuit 6 is disposed at one end of each of the ten wave-shaped detection conductive wires 5, the main current detection circuit 6 includes 8 vertical detection metal wires 601 vertically arranged, the vertical detection metal wires 601 are made of an aluminum alloy material, each of the vertical detection metal wires includes an upper detection conductive metal piece and a lower detection conductive metal piece respectively disposed on an upper surface and a lower surface of the wave-shaped detection conductive wire 5; and junctions between the heating wires 2, the wave-shaped conductive structures 3, and the base layer 1, and junctions between the wave-shaped detection conductive wires 5, the main current detection circuit 6, and the detection layers 4 are all fixed with high-temperature-resistant wires 8 to enhance connection stability.

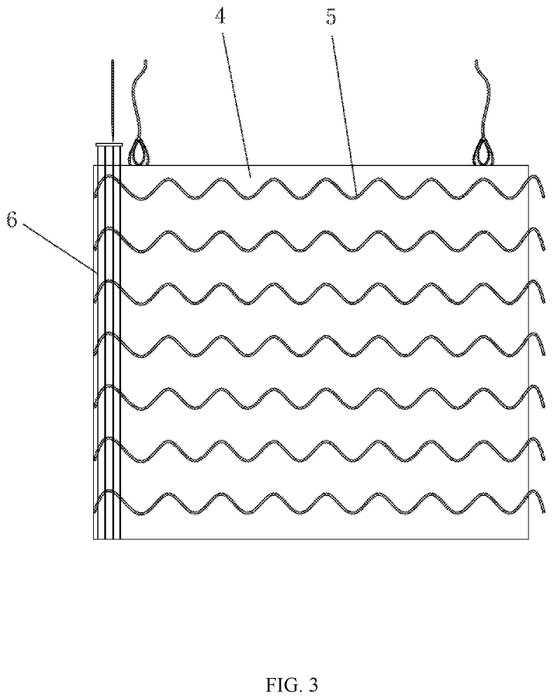

As shown in FIG. 3, each of the wave-shaped detection conductive wires 5 is made of Wood's metal with a melting point of 80 °C and externally wrapped with an outer soft frame 100, a plurality of circular frames 200 are uniformly arranged transversely on an inner side of the outer soft frame 100, and the wave-shaped detection conductive wire 5 penetrates through the plurality of circular frames 200 along a wave-shaped path; and an outer layer 300 is disposed on an outer side of the plurality of outer soft frames 100, and the outer layer 300 is made of a PVC material to enclose the plurality of circular frames 200 and prevent external impurities from affecting the operation of the wave-shaped detection conductive wires 5.

The electrothermal conductive structure further includes a positive-electrode conductive structure 30 and a negative-electrode conductive structure 40 respectively connected to both ends of the 10 heating wires 2, and the positive-electrode conductive structure 30 and the negative-electrode conductive structure 40 are electrically connected to the wave-shaped conductive structure 3 respectively; and outer sides of the 10 heating wires 2 are covered with a meltable layer 50, the meltable layer 50 is made of a low-melting-point hot-melt material, an outer side of the meltable layer 50 is covered with a conductive detection layer 60, a carbon nanotube conductive coating 110 is disposed on a surface of the conductive detection layer 60, graphene heat dissipation sheets are embedded in the carbon nanotube conductive coating 110, and the graphene heat dissipation sheets and the conductive detection layer 60 collectively form a composite conductive heat dissipation structure 2000 to achieve coordination of electric conduction and heat dissipation.

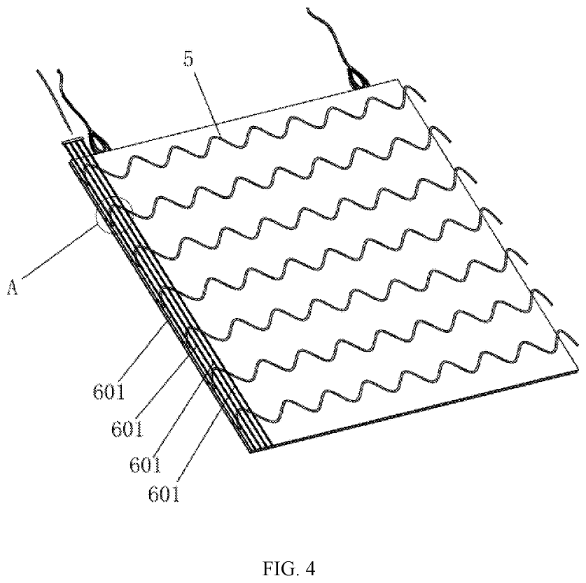

A uniform heat dissipation layer 130 is further disposed between the base layer 1 and the 10 heating wires 2, as shown in FIG. 4, the uniform heat dissipation layer 130 includes a high thermal conductivity layer 1310, a medium thermal conductivity layer 1320, and a low thermal conductivity layer 1330, the high thermal conductivity layer 1310 is arranged in contact with the heating wires 2 and made of a graphene composite material, the medium thermal conductivity layer 1320 is made of a carbon nanotube composite material, and the low thermal conductivity layer 1330 is arranged in contact with the base layer 1 and made of an epoxy resin composite material; and the high thermal conductivity layer 1310, the medium thermal conductivity layer 1320, and the low thermal conductivity layer 1330 are each filled with thermally conductive particles 1001 of different particle sizes, the thermally conductive particles in the high thermal conductivity layer 1310 have a particle size of 5-10 μm, the thermally conductive particles in the medium thermal conductivity layer 1320 have a particle size of 10-20 μm, and the thermally conductive particles in the low thermal conductivity layer 1330 have a particle size of 20-30 μm, thereby achieving uniform heat conduction, where
an aerogel thermal insulation buffer layer 90 is disposed between the base layer 1 and the meltable layer 50, the aerogel thermal insulation buffer layer 90 has a honeycomb structure, 20 micro temperature sensors 1000 are uniformly distributed in the aerogel thermal insulation buffer layer, and the micro temperature sensors 1000 are electrically connected to the controller 7 for auxiliary temperature detection of the electric heating structure.

The controller 7 has a relay structure and is electrically connected to the main current detection circuit 6, the conductive detection layer 60, and the wave-shaped conductive structure 3 respectively; and the controller 7 is electrically connected to a control switch, and the control switch is electrically connected to the positive-electrode conductive structure 30 and the negative-electrode conductive structure 40 and configured to control connection and disconnection of a main power supply circuit.
S1, the controller 7 has a relay structure, a detection terminal of the controller 7 is electrically connected to the main current detection circuit 6, the micro temperature sensors 1000 collect temperature signals of the electric heating structure in real time and transmit the signals to the controller 7, and the controller 7 is in a standby detection state;
S2, during long-term operation of the electric heating structure, when a local temperature of one of the heating wires 2 exceeds 80 °C due to poor contact, the detection layer 4 at a corresponding position melts due to heating;
S3, after the detection layer 4 melts, the heating wire 2 at a corresponding position directly comes into contact with the wave-shaped detection conductive wire 5 to generate an electric current, and the electric current is transmitted to the wave-shaped detection conductive wire 5;
S4, the wave-shaped detection conductive wire 5 transmits the current signal to the controller 7 through the vertical detection metal wires 601 of the main current detection circuit 6, and the controller 7 simultaneously receives a high-temperature signal transmitted by the micro temperature sensors 1000 to double-confirm local overheating;
S5, the controller 7 immediately sends a control signal to disconnect the control switch, and cuts off a main power supply circuit of the positive-electrode conductive structure 30 and the negative-electrode conductive structure 40 to achieve overheating protection;
S6, since the wave-shaped detection conductive wire 5 is made of Wood's metal with a melting point of 80 °C, the wave-shaped detection conductive wire 5 at a corresponding position melts synchronously under the high temperature of the heating wire 2;
S7, a molten solution of the wave-shaped detection conductive wire 5 flows and covers an interior of the corresponding circular frame 200 to prevent loss of the solution;
S8, the molten solution of the wave-shaped detection conductive wire 5 increases its own coverage area to more stably receive a current signal from the heating wire 2 at the corresponding position, thereby preventing failure of electric signal transmission caused by a hollow gap between the wave-shaped detection conductive wires 5 wavily arranged and the heating wires 2 linearly arranged, and ensuring the controller 7 reliably receives an overheating signal, and preventing misjudgment or missed judgment.

After the fault is eliminated, normal operation of the electric heating structure is restored only by replacing the melted wave-shaped detection conductive wire 5 and the detection layer 4, with maintenance convenience and low cost.

The basic principles, main features and advantages of the present disclosure are shown and described above. It should be understood by those skilled in the art that the present disclosure is not limited by the foregoing examples, the descriptions in the foregoing examples and the specification are merely illustrative of the principles of the present disclosure, various changes and improvements will be made in the present disclosure without departing from the spirit and scope of the present disclosure, and all these changes and improvements fall within the scope of the present disclosure. The claimed protection scope of the present disclosure is defined by the appended claims and equivalents thereof.

What is claimed is:

1. An electric heating structure with an overheating protection layer, comprising a base layer (1), wherein an electrothermal conductive structure is disposed in the base layer (1); the electrothermal conductive structure comprises a plurality of heating wires (2) uniformly distributed in the base layer (1), and a wave-shaped conductive structure (3) is electrically connected between both ends of each of the heating wires (2); detection layers (4) are respectively disposed on both sides of the base layer (1), and wave-shaped detection conductive wires (5) equal in number to the heating wires (2) are uniformly distributed on outer surfaces of the detection layers (4); a main current detection circuit (6) is disposed between a plurality of the wave-shaped detection conductive wires (5);
junctions between the heating wires (2), the wave-shaped conductive structures (3), and the base layer (1) are fixed with high-temperature-resistant wires (8);
junctions between the wave-shaped detection conductive wires (5), the main current detection circuit (6), and the detection layers (4) are also fixed by the high-temperature-resistant wires (8); and
further comprising a controller (7), wherein the controller (7) is electrically connected to the main current detection circuit (6) and the wave-shaped conductive structure (3) respectively;
the electrothermal conductive structure further comprises a positive-electrode conductive structure (30) and a negative-electrode conductive structure (40) respectively connected to both ends of the plurality of heating wires (2);
outer sides of the plurality of heating wires (2) are covered with a meltable layer (50), and an outer side of the meltable layer (50) is covered with a conductive detection layer (60);
the conductive detection layer (60) is electrically connected to the controller (7), the controller (7) is electrically connected to a control switch, the control switch is electrically connected to the positive-electrode conductive structure (30) and the negative-electrode conductive structure (40), and the positive-electrode conductive structure (30) and the negative-electrode conductive structure (40) are electrically connected to the wave-shaped conductive structure (3) respectively;
a carbon nanotube conductive coating (110) is disposed on a surface of the conductive detection layer (60), and graphene heat dissipation sheets are embedded in the carbon nanotube conductive coating (110); and
a uniform heat dissipation layer (130) is further disposed between the base layer

(1) and the plurality of heating wires (2).

2. The electric heating structure with an overheating protection layer according to claim 1, wherein the base layer (1) and the detection layers (4) are made of a material such as non-woven fabric or a PVC film;
the heating wires (2) are made of a material such as carbon fiber, nickel-chromium alloy, chromium-aluminum alloy, tungsten wire, or molybdenum wire;
the wave-shaped conductive structure (3) comprises a plurality of wave-shaped conductive wire sets (301) vertically arranged;
each of the wave-shaped conductive wire sets (301) comprises two parallel wave-shaped conductive wire sets (302) bilaterally arranged in a symmetrical manner;
the plurality of wave-shaped conductive wire sets (301) and the plurality of heating wires (2) are arranged in a staggered manner;
the two parallel wave-shaped conductive wire sets (302) are arranged in a staggered manner, and the heating wire (2) is disposed between the two parallel wave-shaped conductive wire sets (302);
each of the parallel wave-shaped conductive wire sets (302) comprises two wave-shaped conductive wires (303) extending in parallel along an S-shaped path;
each of the wave-shaped detection conductive wires (5) is S-shaped and wave-shaped, and correspondingly overlapped on an outer side of one of the heating wires (2), and electrical signal isolation is achieved via the detection layer (4);
wave-shaped arrangement of the wave-shaped detection conductive wires (5) increases a detection coverage range for local overheating of the heating wires (2);
the main current detection circuit (6) comprises a plurality of vertical detection metal wires (601) vertically arranged; and
each of the vertical detection metal wires (601) comprises an upper detection conductive metal piece and a lower detection conductive metal piece respectively disposed on an upper surface and a lower surface of the wave-shaped detection conductive wire (5).

3. The electric heating structure with an overheating protection layer according to claim 2, wherein the vertical detection metal wires (601) are made of one of copper, aluminum alloy, or stainless steel;
the wave-shaped detection conductive wires (5) are made of Wood's metal;
each of the wave-shaped detection conductive wires (5) is externally wrapped with an outer soft frame (100), a plurality of circular frames (200) are uniformly arranged transversely on an inner side of the outer soft frame (100), and the wave-shaped detection conductive wire (5) penetrates through the plurality of circular frames (200) along a wave-shaped path; and
an outer layer (300) is disposed on an outer side of the plurality of outer soft frames (100), and the outer layer (300) is configured to enclose the plurality of circular frames (200).

4. The electric heating structure with an overheating protection layer according to claim 1, wherein the plurality of heating wires (2) are arranged parallel to each other and spaced apart from each other in a vertical direction of the base layer (1).

5. The electric heating structure with an overheating protection layer according to claim 4, wherein a wave-shaped conductive line structure (140) comprises two wave-shaped conductive lines (141) that are bilaterally arranged in a symmetrical and staggered manner, and the wave-shaped conductive lines (141) are electrically connected to corresponding ends of the heating wires (2).

6. The electric heating structure with an overheating protection layer according to claim 5, wherein junctions between the wave-shaped conductive lines (141) and the heating wires (2) are fixed by the high-temperature-resistant wires;
the meltable layer (50) is made of a low-melting-point hot-melt material; and
the uniform heat dissipation layer (130) comprises a high thermal conductivity layer (1310), a medium thermal conductivity layer (1320), and a low thermal conductivity layer (1330), the high thermal conductivity layer (1310) is arranged in contact with the plurality of heating wires (2), and the low thermal conductivity layer (1330) is arranged in contact with the base layer (1).

7. The electric heating structure with an overheating protection layer according to claim 6, wherein the high thermal conductivity layer (1310), the medium thermal conductivity layer (1320), and the low thermal conductivity layer (1330) are each filled with thermally conductive particles (1001) of different particle sizes;
the high thermal conductivity layer (1310) is made of a graphene composite material or a boron nitride composite material; and
the medium thermal conductivity layer (1320) is made of a carbon nanotube composite material or an epoxy resin composite material.

8. The electric heating structure with an overheating protection layer according to claim 7, wherein an aerogel thermal insulation buffer layer (90) is disposed between the base layer (1) and the meltable layer (50), and the aerogel thermal insulation buffer layer (90) has a honeycomb structure;
a plurality of micro temperature sensors (1000) are uniformly distributed in the aerogel thermal insulation buffer layer (90), and the micro temperature sensors (1000) are electrically connected to the controller (7); and
the graphene heat dissipation sheets and the conductive detection layer (60) collectively form a composite conductive heat dissipation structure (2000).

9. A control method for an overheating protection layer, applied to the electric heating structure with an overheating protection layer according to claim 8, comprising the following control steps:
S1, the controller (7) employs a relay or electronic switch circuit structure, and a detection terminal of the controller (7) is electrically connected to the main current detection circuit (6);
S2, when a local temperature of the electric heating structure is excessively high such that temperature anomaly occurs at a certain position of one of the heating wires (2), the detection layer (4) at a corresponding position melts;
S3, after the detection layer (4) melts, the heating wire (2) at a corresponding position comes into contact with the wave-shaped detection conductive wire (5) to generate an electric current, and the electric current is transmitted to the wave-shaped detection conductive wire (5);
S4, the wave-shaped detection conductive wire (5) transmits a current signal to the controller (7) through the main current detection circuit (6); and
S5, the controller (7) cuts off a main power supply circuit of the positive-electrode conductive structure (30) and the negative-electrode conductive structure (40) according to the received current signal.

10. The control method for an overheating protection layer, applied to the electric heating structure with an overheating protection layer according to claim 8, further comprising the following control steps:
S6, the wave-shaped detection conductive wire (5) made of Wood's metal has a melting point ranging from 70 °C to 90 °C; when the local temperature of the electric heating structure is excessively high, the heating wire (2) melts the wave-shaped detection conductive wire (5) at a corresponding position;
S7, after the wave-shaped detection conductive wire (5) at the corresponding position melts, a resulting molten solution covers an interior of the corresponding circular frame (200); and
S8, a coverage area of the wave-shaped detection conductive wire (5) is increased to stably receive a current signal from the heating wire (2) at the corresponding position, thereby preventing failure of electric signal transmission caused by a hollow gap between the wave-shaped detection conductive wires (5) wavily arranged and the heating wires (2) linearly arranged.
